(19) United States
(12) Patent Application Publication
(10) Pub. No.: US 2026/0093831 A1
(43) Pub. Date: Apr. 2, 2026

(54) METHOD FOR TRUST BINDING AND ENROLLMENT TO SECURE TRUST DOMAINS

(71) Applicant: NBCUniversal Media, LLC, New York, NY (US)

(72) Inventors: Andrea Elaine Avila Weiler, Los Angeles, CA (US); Robert Glenn Deen, Simi Valley, CA (US)

(21) Appl. No.: 18/899,702

(22) Filed: Sep. 27, 2024

(51) Int. Cl. G06F 21/62; G06F 21/60

(52) U.S. Cl. CPC G06F 21/6209; G06F 21/602

(57) ABSTRACT

An improved method is provided methods for passively binding one or more devices into a security trust domain through audio signals transmitted from a trust-facilitating service and enable media playback of protected digital content on the one or more devices. The method may include receiving, from the trusted device, an audio signal, where the audio signal includes embedded access information configured to enable access to protected content from the one or more devices. As such, the one or more devices may decrypt, decode, or both, the access information from the audio signal and gain access to the protected digital content.

### BACKGROUND

This disclosure relates generally to playing protected content and, more particularly, but not exclusively, to binding (e.g., pairing) devices into a security trust domain (e.g., a security state or authorization realm) to enable trusted access to content (e.g., concurrent audio and/or visual media playback of digital rights management (DRM) protected digital content).

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Digital rights management (DRM) techniques provide protections for managing access rights to digital content and enforcing copyright compliance. For example, a device may be required to be bound (e.g., paired) into a security trust domain (e.g., a security state or authorization realm) to enable audio and/or visual media playback of DRM protected digital content. That is, the device may present certain authorization or enrollment inputs, such as a correct combination of a username and a password and/or a correct answer to a security question, and/or other security parameters, such as link encryption, to a DRM server before the DRM server authorizes the device and provides DRM protected digital content to the device. In this regard, the device may become a trusted device once it has the required security capabilities and protocols in place.

While the device, once trusted, may have seamless access to the DRM protected digital content, an additional device nearby may seek to gain such access to enable concurrent media playback of the DRM protected digital content. For example, in a home theater, a yet-to-be-trusted speaker may seek to gain access to output audio playback of the DRM protected digital content concurrent to visual media playback of the DRM protected digital content displayed by a trusted projector. Some of these DRM techniques, while effective in providing robust content security, may also become burdensome when multiple devices are seeking access to the DRM protected digital content. Traditionally, tedious techniques may be employed to enable multiple devices to be bound (e.g., paired) into the security trust domain (e.g., the security state or authorization realm). For example, traditional techniques may require a user to manually provide authorization or enrollment inputs repeatedly to authorize multiple devices and, thus, negatively affect the user experience. Further, such traditional techniques may act as a technological barrier when non-traditional (e.g., specialized) devices that may not support the techniques, such as hearing aids, ear pods, and secondary devices for providing closed captioning, are seeking to be authorized. As such, robust systems and methods that may bind (e.g., pair) multiple devices into a security trust domain (e.g., a security state or authorization realm) to enable these devices for concurrent audio and/or visual media playback of the DRM protected digital content may be desirable.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an aspect of the present disclosure, a method may include receiving, at a first electronic device, an audio signal, where the audio signal includes embedded trust data configured to enable access to protected content. The method may also include extracting, via the first electronic device, the trust data from the audio signal. The method may further include accessing at least a portion of the protected content using the extracted trust data.

In accordance with another aspect of the present disclosure, a system may include an audio signal provider configured to provide an audio signal, where the audio signal includes embedded access information configured to enable access to protected content. The system may also include a first electronic device configured to receive the audio signal from the audio signal provider and present the audio signal. The first electronic device may enable a second electronic device to receive the audio signal, decrypt, decode, or both, the access information from the audio signal, and access at least a portion of the protected content using the access information.

In accordance with a further aspect of the present disclosure, a tangible, non-transitory, computer-readable medium, including computer-readable instructions that, when executed by one or more processors of one or more computers, causes the one or more computers to provide environment-based access to protected content by one or more electronic devices. The providing may be accomplished by presenting, in an access-authorized environment, an audio signal, where the audio signal includes embedded access information useful for the one or more playback devices to access the protected content.

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagram of a system for facilitating access rights to protected digital content, where the system may employ audio signals including trust data associated with the protected content to enable media playback, in accordance with certain aspects of the present technique;

FIG. 2 is a diagram of an embodiment of the system of FIG. 1 for facilitating access rights to protected digital content, in accordance with certain aspects of the present technique;

FIG. 3 is a process flow diagram illustrating a method, by which the system of FIG. 1 and the like may bind a trust-based access service into a security trust domain through an audio signal outputted from a trust-facilitating service to gain access to protected content or a portion of the protected content, in accordance with certain aspects of the present technique;

FIG. 4 is a process flow diagram illustrating a method, by which the system of FIG. 1 and the like may bind a device associated with a trust-based access service into the security trust domain through the use of audio-based trust data, in accordance with certain aspects of the present technique; and

FIG. 5 is a diagram of a DRM system including the system of FIG. 1 for controlling and tracking playback of protected content, in accordance with certain aspects of the present technique.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional aspects that also incorporate the recited features.

In the following description, for the purposes of explanation, numerous specific details are set forth in order to provide a thorough understanding of aspects of the present disclosure. It will be apparent, however, to one skilled in the art that aspects of the present disclosure may be practiced without some of these specific details.

As used herein, the term “application” may refer to one or more computing modules, programs, processes, workloads, threads, and/or computing instructions executed by a computing system. Example embodiments of an application include software modules, software objects, software instances, and/or other types of executable code.

As used herein, the terms “automatic” and “automatically” refer to actions that are performed by a computing device or computing system (e.g., of one or more computing devices) without human intervention. For example, automatically performed functions may be performed by computing devices or systems based solely on data stored on and/or received by the computing devices or systems despite the fact that no human users have prompted the computing devices or systems to perform such functions. As but one non-limiting example, the computing devices or systems may make decisions and/or initiate other functions based solely on the decisions made by the computing devices or systems, regardless of any other inputs relating to the decisions.

As used herein, the terms “real time” and “substantially real time” may refer to actions that are performed substantially simultaneously with other actions, without any human-perceptible delay between the actions. For example, two functions performed in substantially real time occur within seconds (or even within milliseconds) of each other. As but one non-limiting example, two functions performed in substantially real time occur within 1 second, within 0.1 second, within 0.01 second, and so forth, of each other.

As used herein, terms “continuous” and “continuously” may refer to ongoing (e.g., iterative) actions that are performed without interruption or are performed with interruptions that take no longer than a relatively short period of time, such as no longer than a 5-second interruption between the ongoing actions, no longer than a 1-second interruption between the ongoing actions, and so forth. For example, continuous ongoing actions may be performed in an iterative manner such that there is no appreciable (e.g., human-perceivable) interruption of the iterative actions.

As noted above, there remains a need for improved systems and methods for passively authorizing multiple devices to enable concurrent audio and/or visual media playback of protected digital content. With this in mind, present embodiments are directed to authorization techniques that may require little to no manual user inputs and may be imperceptible to users generally. Further, presently disclosed authorization techniques may require little, if any, new hardware components over traditional content delivery approaches. To accomplish this, the presently disclosed authorization techniques may employ audio-based signals to initiate trust binding between a first entity (e.g., an electronic device and/or owner of an electronic device and/or owner of digital protected content) having access to protected digital content (e.g., DRM protected digital content) and a second entity (e.g., an electronic device and/or operator of an electronic device) seeking access to the protected digital content. Specifically, the first entity may output an audio signal corresponding to (e.g., embedded in) the protected digital content and having audio-based trust data therein, which may be detected and decrypted by the second entity. The second entity may be bound into a security trust domain (e.g., a security state or authorization realm) upon decrypting the audio-based trust data and provided access to the DRM protected digital content (or a portion thereof) that is already accessible to the first device. Further, in some aspects, once the second entity successfully is trusted to access the DRM protected digital content, the second entity may take the roles of accessing the protected content and/or sharing the audio-based signals corresponding to the protected content. That is, after the second entity is bound into the security trust domain, the second entity may output the audio signal corresponding to the audio-based trust data, and a third entity may access the DRM protected digital content (or a portion thereof) in response to detecting the audio-based signal and decrypting the audio-based trust data. As such, presently disclosed authorization techniques may passively bind (e.g., pair) one or more additional entities into a security trust domain through audio signals transmitted from a trusted entity and grant access to DRM protected digital content from the one or more additional entities. This may provide significant value over traditional protection systems, as the security trust domain may be established based upon an electronic device being in an eligible environment for access to protected content, which may be established based upon the electronic device's ability to hear, receive, or detect the audio signal, which may be provided exclusively within the eligible environment.

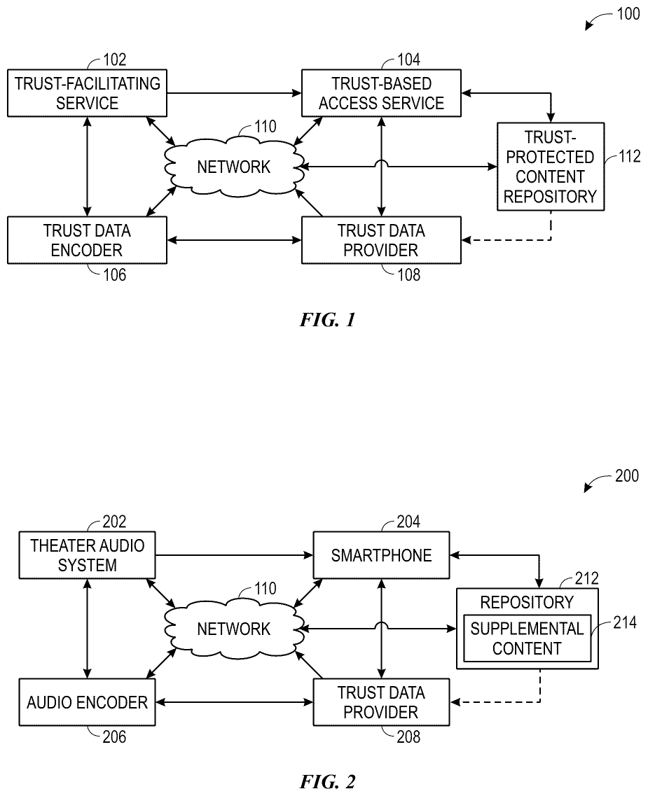

FIG. 1 is a diagram of a system 100 for facilitating access rights to protected digital content, where the system 100 may employ audio signals including trust data associated with the protected digital content to enable media playback. As illustrated, the system 100 includes a trust-facilitating service 102 that has been trusted to access the protected digital content (e.g., from the perspective of a content server) and is configured to broadcast an audio signal. For example, the trust-facilitating service 102 may include a speaker/audio system. The audio signal may correspond to certain protected digital content, such as a video, an audio clip, an image, a textual document, a digital token, a digital object, digital information, a combination thereof, or any other protected digital content. The audio signal may include audio-based trust data that may initiate trust binding for a trust-based access service 104, which is not trusted (e.g., from the perspective of the content server) yet and is seeking to bind into a security trust domain and access the protected content.

More specifically, the trust-facilitating service 102 and/or the trust-based access service 104 may include, for example, a television, a smartphone, a tablet, a Digital Video Disc (DVD) player, a Blu-ray player, a gaming console, an audio/visual (AV) receiver, a speaker, a personal computer, a laptop, a communications device, any other electronic device suitable for providing trust data used to facilitate access of the protected content, such as by providing a trust data payload in an audio stream presented to a trust-based access service (e.g., a service of an electronic device used to access the protected content using the trust data). The protected content may include or otherwise be associated with, for example, streamed content, downloadable content, a DVD, a Blu-ray disc, etc.

The trust-based access service 104, if trusted, may gain access to at least a portion of the protected digital content and/or provide media playback of the at least a portion of the protected digital content. For example, in the context of a theater, the trust-facilitating service 102 may include a speaker system configured to broadcast audio signals, such as audio playback of a protected content and/or audio-based trust data corresponding to the protected content. The audio signals may be received by an electronic device executing the trust-based access service 104, such as via a listening device (e.g., microphone) that detects the audio signals broadcasted by the trust-facilitating service 102 and extracts the audio-based trust data. Using the audio-based trust data (e.g., decrypting the protected content using the audio-based trust data), the trust-based access service 104 may be passively bound into a security trust domain and granted access to at least a portion of the protected content without manually providing any authorization or enrollment inputs. For example, again in the context of the theater, the trust-based access service 104 may include a set of headphones that may be trusted to access a specialized soundtrack of the protected content, such as a soundtrack corresponding to a specific language. This trust may be facilitated by the audio-based trust data received via the headphones (or another device coupled to the headphones), which may be used to access (e.g., decrypt) the protected (e.g., encrypted) digital content. These and other aspects of the audio-based trust data are described in detail below. A trust data encoder 106 may encode the trust data provided by a trust data provider 108 to generate the audio-based trust data to be broadcasted by the trust-facilitating service 102. The trust data may include information or at least a portion of the information to access and/or provide media playback of the protected digital content. For example, the trust data may include authentication information (e.g., a correct combination of a username and a password and/or a correct answer to a security question, and/or other security parameters) and/or address information (e.g., a URL) to access a trust-protected content repository 112, cryptographic information (e.g., a cryptographic key) corresponding to the protected content, and/or any other information that may enable the trust-based access service 104 to access the protected digital content. More specifically, in some aspects where the trust data includes a cryptographic key, the cryptographic key may be generated using any suitable encryption algorithm, such as Rivest-Shamir-Adleman (RSA) algorithm, Advanced Encryption Standard (AES), or Elliptic Curve Cryptographic (ECC) algorithm or single or distinct multikey Broadcast Encryption algorithms. In some aspects, Adaptive Pseudo-Randomness Extraction (APRE) methods and algorithms may be implemented to enhance efficiency and security of generating pseudo-random numbers of sequences used in the generation of the cryptographic key. By way of example, the length of the cryptographic key may be 128, 192, 256, 512, 1024, or a predetermined number of bits.

Alternatively, the trust data may include a first piece of trust data corresponding to a complementary second piece of trust data known to the trust-based access service 104 a priori, where the combination of the first piece of trust data and the complementary second piece of trust data may enable the trust-based access service 104 to access the protected content. For example, the first piece of trust data may be an encoded and/or encrypted form of the trust data, and the second piece of trust data may be a corresponding decoding and/or decryption scheme to the encrypted trust data, or vice versa. As another example, the first piece of trust data and the second piece of trust data may cause a multivariate computational function to generate a value corresponding to the access information of the protected content. In some aspects, the generated value may be a decryption key corresponding to the protected content. Alternatively, the computational function may be a hash function configured to generate unique hash digests specific to different input data, and, if the generated value matches a specific value, the trust-based access service 104 may be enabled to access the protected content.

As previously mentioned, the trust data encoder 106 may encode the trust data to generate the audio-based trust data, which may be broadcasted as audio signals. The conversion from the trust data to the audio-based trust data may involve any suitable text-to-speech techniques. In some aspects, the trust data may be first encoded into a numerical or binary code prior to such conversion. The audio-based trust data may be modulated by applying modulation techniques, such as amplitude modulation, frequency modulation, phase modulation, filter modulation and/or any other suitable techniques. In some aspects, the trust data encoder 106 may also embed an audio watermark in the generated audio-based trust data. By embedding the audio watermark, which is typically undetectable to the human ear but identifiable to a listening device, the system 100 may have greater flexibility to protect authenticity of the audio-based trust data and monitor the distribution of the trust data, without affecting the quality of the audio signals.

Subsequently, the trust data encoder 106 may provide the audio-based trust data to the trust-facilitating service 102, which may in turn broadcast the audio signal including the audio-based trust data to the trust-based access service 104. In some aspects, the audio-based trust data is broadcasted alone. In other aspects, the audio-based trust data is embedded in another audio signal (e.g., an audio signal corresponding to the protected content). For example, the audio-based trust data may be added to the audio signal as a voice-over layer through a watermarking software, where an encoding algorithm is employed to subtly modify the amplitude of the audio signal such that the trust data may become difficult to remove. In some aspects, the audio-based trust data may include a frequency or other characteristic(s) causing the audio-based trust data to be imperceptible and/or obscured to human ears. For example, the audio-based trust data may have a frequency outside of the audible range of 20 Hz to 20,000 Hz. As such, the audio-based trust data may be broadcasted without interfering with any other sounds or negatively affecting the hearing experience of anyone within the signal range of other audio signals. Although imperceptible to human ears, the audio-based trust data may be easily detected by the trust-based access service 104.

The trust-based access service 104 may be configured to detect audio signals. For example, the trust-based access service 104 may include a listening device (e.g., microphone) configured to detect audio signals. As noted previously, the trust binding may be initiated upon the detection of the audio signal and extraction of the audio-based trust data, which may be enabled by a physical proximity between the trust-facilitating service 102 and the trust-based access service 104. That is, the listening device of the trust-based access service 104 may be required to present within a certain distance from the speaker/audio system of the trust-facilitating service 102 (e.g., within an audio signal range) to enable detection of any audio signals broadcasted by the trust-facilitating service 102. In this way, the present disclosure relies on trust indicated by the physical proximity between the trust-facilitating service 102 and the trust-based access service 104.

The trust-based access service 104 may also be configured to process (e.g., decrypt and/or decode) information in the audio signals. In some aspects, the trust-based access service 104 may include a software-based cryptographic lock that may be unlocked in response to receiving the audio signal and decrypting (or decoding) the audio-based trust data included in the audio signal. The cryptographic lock may be provided by a trust data provider 108 and stored at the trust-based access service 104 at a time of manufacture or at another time. For example, the cryptographic lock may be included in an operating system update, included in a downloadable app, provided in an electronic communication with the trust-based access service 104, etc. Once the cryptographic lock is stored in the trust-based access service 104, binding the trust-based access service 104 into a security trust domain may automatically occur without any manual user inputs. That is, the trust-based access service 104 may be automatically authorized to access certain protected content in response to receiving the audio signal and interfacing the corresponding audio-based trust data with the cryptographic lock of the trust-based access service 104, resulting in an automatically-established trust relationship. As such, the trust-based access service 104, although not initially trusted (e.g., from the perspective of the content server), may unlock the software-based cryptographic lock and become bound into the security trust domain to access protected content.

In some aspects, upon being bound into the security trust domain, the trust-based access service 104 may receive additional audio signals indicative of the protected content or data associated with the protected content from the trust-facilitating service 102. For example, the trust-facilitating service 102 may transmit the protected content to the trust-based access service 104 for media playback via additional audio signals. In some aspects, upon being bound into the security trust domain with the trust-facilitating service 102, the trust-based access service 104 may gain access to the protected content accessible to the trust-facilitating service 102 and become enabled for media playback of the protected content. For example, the trust-facilitating service 102 and the trust-based access service 104 may become paired to provide concurrent media playback of the protected content in response to the trust-based access service 104 decrypting or decoding the audio-based trust data. In some aspects, the trust-based access service 104 may be trusted to access any protected content accessible to the trust-facilitating service 102.

In some aspects, the trust-based access service 104 may gain access to only a portion of the protected content, such as a specialized audio track associated with the protected content, upon being bound into the security trust domain. As such, the trust-based access service 104 may provide specialized audio content playback to a particular user (e.g., user of the trust-based access service 104). For example, the specialized audio track may include an audio track in a particular language or an audio track for specialized devices such as hearing aids. In some aspects, the system 100 may be configured such that the trust-facilitating service 102 may output a combination of audio-based trust data, certain protected digital content in a general format, which may be intended for a general audience and audible to human ears, and the certain protected digital content in a specialized format, which may be intended for a special target audience and encrypted and/or encoded to be inaudible to human ears to block disruption to the general audience. The trust-based access service 104, upon detection of the outputted combination of audio signals from the trust-facilitating service 102, may decrypt and/or decode specific information from the combined audio signals to enable playback of the specialized content via the trust-based access service 104 to the special target audience. For example, the system 100 may be configured such that the trust-facilitating service 102 may output certain protected content to a general audience in a first language and the trust-based access service 104 may be trusted to output the protected content to a second audience in a second language. In some aspects, synchronization techniques may be employed to ensure that the audio is played back on the trust-based access service 104 in-sync with, content (e.g., video or audio) played back on the trust-facilitating service 102.

In some aspects, the trust-based access service 104 may gain access to protected information associated with the protected content, upon being bound into the security trust domain. For example, the trust-based access service 104 may gain access to protected address and/or access information for retrieving files of the protected digital content from a protected content data store. As such, the trust-based access service 104 may locate and retrieve the protected digital content, which may be stored in a secured storage, and subsequently provide media playback of the retrieved files.

In some aspects, the trust-based access service 104 may receive instructions to conduct certain tasks, upon being bound into the security trust domain. In such aspects, the trust-based access service 104 may be configured to provide media playback and/or perform other tasks (e.g., automatically or manually as per user inputs). For example, the trust-based access service 104 may receive instructions from the trust-facilitating service 102 to automatically conduct a web search for information related to certain protected digital content (e.g., plot summaries of a movie) and/or display the information on a display of the trust-based access service 104. Alternatively or additionally, the trust-based access service 104 may provide instructions to the trust-facilitating service 102 (e.g., automatically or manually as per user inputs). For example, the trust-based access service 104 may be authorized to control a device configured to operate interactively based on signals from other devices in the security trust domain. As a more specific example, a user may lock/unlock a door lock via a user device (i.e., a device of the trust-based access service 104), in response to the user device being bound into the security trust domain upon receiving an audio signal outputted from the door lock. In some aspects, the security binding of the trust-based access service 104 may automatically trigger actions of other devices connected to the trust-facilitating service 102 and/or the trust-based access service 104 via Internet of Things (IoT). For example, the binding of the trust-based access service 104 may cause a smart light bulb to be controlled to adjust its brightness and/or color to provide the appropriate ambiance during media playback. As another example, the binding of the trust-based access service 104 may gain access (e.g., unlock a smart door lock) to an area within a certain avenue (e.g., entertainment avenue such as a theme park or an art galleries), where a guest may receive additional trust data to gain access to an additional area. In another example, the binding of the trust-based access service 104 may trigger a special effect or enable interaction with a special effect (e.g., perform an action or gesture to trigger a special effect or interact with a physical object). The triggering of or interaction with the special effect may be associated with the trust-based access service 104 and/or the device associated with the trust-based access service 104 and/or associated with a user profile linked to the device or the trust-based access service 104. As such, the system 100 may be implemented to guide the guest through the avenue in an ordered fashion.

As illustrated in FIG. 1, the trust-facilitating service 102 may be in communication with the trust data encoder 106 via a network 110. The trust data encoder 106, via the network 110, may be configured to receive requests from the trust-facilitating service 102 for audio-based trust data, and provide the trust data to the trust-facilitating service 102 in response to the request. In some instances, the audio signals may be pushed from the trust data encoder 106 to the trust-facilitating service 102 via the network 110.

The network 110 may include various systems for facilitation of communications within system 100 and distribution of audio signals. The network 110 may include any desired combination of hardwired and wireless communication links, including wide area networks (WAN), local area networks (LAN), wireless networks suitable for packet-type communications, over-the-air, satellite, cable, Internet, other network connection systems, etc., which implement networks and hardware known and used in the related art, including broadcast technologies, cable or satellite distribution systems, Internet protocol (IP), or other networked technologies, etc. The system 100 may also include a gateway (not depicted), for example, a server, a router, a firewall server, a host, a proxy server, request redirector, etc.

In some aspects, the trust-based access service 104 may be in communication with a trust-protected content repository 112. For example, upon receiving the audio signals from trust-facilitating service 102, the trust-based access service 104 may process (e.g., decrypt and/or decode) audio-based trust data contained therein to extract access information to acquire protected content stored in the trust-protected content repository 112. In such example, the trust data provider 108 may be in communication with the trust-protected content repository 112 such that the trust data provider 108 may generate trust data corresponding to the access information corresponding to a particular protected content, where the trust data is then encoded by the trust data encoder 106 and broadcasted by the trust-facilitating service 102, before reaching the trust-based access service 104.

In some aspects, the trust-based access service 104 may be in communication with the trust data provider 108 via the network 110. As such, the trust data provider 108 may generate audio-based trust data corresponding to the trust-based access service 104. For example, the trust data provider 108 may encrypt certain data to generate the cryptographic lock stored in the trust-based access service 104 via an encryption key, and, accordingly, generate a corresponding decryption key specific to unlock (e.g., decrypt) the cryptographic lock. In some aspects, the trust data encoder 106 and the trust data provider 108 are essentially the same entity to generate the encryption and decryption keys, which facilitates the provision of the audio signal and cryptographic lock to their respective recipients. In some aspects, the encryption key and the decryption key are symmetric (e.g., the same key). In such aspects, encryption and decryption relies on a single shared key. In other aspects, the encryption key and the decryption key are asymmetric (e.g., distinct) for improved security. In such aspects, the encryption key may be publicly shared to encrypt any data associated with the protected content without compromising security, while the decryption key may only be shared amongst trusted devices through audio signals.

In some aspects, the trust data provider 108 may provide the cryptographic lock to the trust-based access service 104 as needed via the network 110. For example, the trust data provider 108 may only provide the cryptographic lock to the trust-based access service 104 within a certain time window. As another example, the trust data provider 108 may refuse to provide the cryptographic lock to the trust-based access service 104 if it determines, via the network 110, that the trust-based access service 104 is not in a particular geographical region any more.

Such communication between the trust-based access service 104 and the trust data provider 108 may also enable selective media playback of the protected content. For example, the trust-facilitating service 102 may broadcast multiple audio signals, each corresponding to a decryption key to a distinct aspect (e.g., audio track, visual track, or a combination thereof) of the protected content. The trust data provider 108 may provide a particular cryptographic lock to the trust-based access service 104, such that the particular cryptographic lock may only interface a particular audio signal or the multiple audio signals and hence enable media playback or a particular aspect of the protected content on the trust-based access service 104. As a more specific example, the trust-facilitating service 102 may broadcast multiple audio signals, each corresponding to a decryption key to a distinct language audio track. The trust data provider 108 may provide a particular cryptographic lock to the trust-based access service 104 to selectively enable media playback of a particular language audio track on the trust-based access service 104.

In some aspects, the system 100 may be configured to provide selective media playback based on configurations of the trust-based access service 104, inputs of a user of the trust-based access service 104, or other information related to the user and/or the trust-based access service 104. For example, the system 100 may be configured to provide different types of selective media playback corresponding to different status tiers of users, such as such as paid subscribers and/or particular paid subscribers (e.g., those on an ad-supported tier, a premium tier, and/or a non-premium tier). As such, the system 100 may be implemented with a tiered approach to provide particular content to particular users who opt for a particular tier in advance by tailoring the cryptographic lock and/or the audio signal to corresponding tiers. For example, the system 100 may provide a first type of selective media playback (e.g., premium media playback) on a first device through the trust-based access service 104 to a first user associated with a first status tier (e.g., premium status tier) and a second type of selective media playback (e.g., non-premium media playback) on a second device through the trust-based access service 104 to a second user associated with a second status tier (e.g., non-premium status tier). Further, a first user subscribing to a higher tier (e.g., the premium status tier) of service may receive a higher quality or volume of protected content than a second user subscribing to a lower tier (e.g., the non-premium tier). For example, guests at a concert, sporting event, theme park, mall, or any other suitable venue may be eligible to access different tiers of protected content distributed by the venue through their guest devices, which may be configured to receive audio-based trust data and provide media playback at the venue. The protected content may include certain benefits, such as free songs, unreleased songs, acoustic versions of songs, deluxe albums, sports statistics, sports replays or highlights, non-fungible tokens, private event schedules, exclusive discount information etc., which may only be accessible to certain guests (e.g., guests subscribing to certain tier status or above). The guests subscribing to a higher tier (e.g., the premium tier) of service may store a first cryptographic lock in their device (e.g., through an installed application) to enable access to premium content, and the guests subscribing to a lower tier (e.g., the non-premium tier) of service may store a second cryptographic lock in their device to enable access to non-premium content.

In some aspects, once the trust-based access service 104 successfully accesses the protected digital content, the trust-based access service 104 may take the role of facilitating trust when permitted in some cases. For example, after the trust-based access service 104 is bound into the security trust domain, the trust-facilitating service 102 may transmit the audio-based trust data to the newly-bound trust-based access service 104. As such, the newly-bound trust-based access service 104 may output the audio signal corresponding to the audio-based trust data, and an additional trust-based access service (e.g., executing on an additional electronic device coupled to an electronic device executing the newly-bound trust-based access service 104) may access the protected digital content (or a portion thereof) in response to detecting the audio-based signal, decoding and/or decrypting the audio-based trust data. In this manner, presently disclosed authorization techniques may passively and/or indirectly bind (e.g., pair) one or more trust-based access services or devices in these services into a security trust domain through audio signals transmitted from a trust-facilitating service and enable media playback of protected digital content through the one or more trust-based access services or devices in these services.

Although, with respect to FIG. 1, the cryptographic lock is described to be provided by the trust data provider 108 and the corresponding decryption key is described to be provided by the trust data encoder 106, it is possible to facilitate access rights through an alternative system. In one alternative system, encrypted data (e.g., encrypted content, encrypted data associated with the protected content) is generated by the trust data provider 108, encoded by the trust data encoder 106, and supplied to the trust-based access service 104 through the trust-facilitating service 102 to be decrypted through a decryption key stored in the trust-based access service 104. In another alternative system, encrypted data (e.g., encrypted content, encrypted data associated with the protected content) is encoded by the trust data encoder 106 to be supplied directly to the trust-based access service 104 from the trust data encoder 106 to be decrypted through a decryption key in the trust-based access service 104.

FIG. 2 is a diagram of a system 200, which provides a more specific example of the system 100, for facilitating access rights to protected digital content. As illustrated, the system 200 includes a theater audio system 202 of a movie theater, a smartphone 204 associated with a user, an audio encoder 206, and a trust data provider 108, all of which may be in communication with each other via the network 110. In this example, the user may be a subscriber to a particular service provided at the movie theater. For example, the user may be a subscriber to receive subtitles and/or audio tracks in a different language, special sound tracks for hearing aid devices, additional commentary, additional content, and/or other supplemental content 214 associated with a movie yet not typically offered to a general audience, during showtime of the movie at the movie theater. The trust data provider 108 may generate trust data corresponding to the supplemental content 214 and/or the access information of the supplemental content for the audio encoder 206 (a trust data encoder 106 of FIG. 1) to prepare the audio-based trust data. The audio-based trust data may be modulated such that it may not interfere with other audio signals in the movie theater and/or it is imperceptible to the general public at the movie theater. The audio-based trust data is then provided to the theater audio system 202 (e.g., a trust-facilitating service 102 of FIG. 1). As the user carrying the smartphone 204 approaches the theater, where the theater audio system 202 is located, the smartphone 204 (e.g., a trust-based access service 104 of FIG. 1) may begin receiving audio including the audio-based trust data outputted from the theater audio system 202. Without any manual input of the user, the smartphone 204 may become passively bound into a security trust domain by extracting the audio-based trust data from the audio emitted from the theater audio system 202. For example, with the established trust, the smartphone 204 may access the supplemental content 214 (e.g., via decryption of the supplemental content 214 using the trust data).

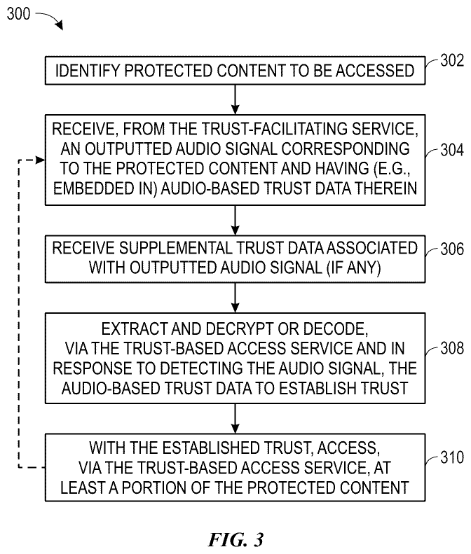

FIG. 3 is a process flow diagram illustrating a method 300, by which a system (e.g., the system 100 and system 200) may bind the trust-based access service 104 into a security trust domain through an audio signal outputted from the trust-facilitating service 102 to gain access to protected content (e.g., Digital Rights Management (DRM) protected content or a portion of the DRM protected content). It should be noted that the steps of the method 300 illustrated in FIG. 3 and described in detail below are exemplary and should not be taken to necessarily imply a chronological order of the method 300. While the steps of the method 300 may be performed in the order illustrated in FIG. 3, presently disclosed embodiments include any suitable ordering and/or chronology of these steps. Further, certain aspects of the method 300 may include steps other than those illustrated in FIG. 3. Further still, certain steps of the method 300 illustrated in FIG. 3 may be omitted and/or altered in other aspects.

In general, the method 300 is configured to leverage or rely upon environment-based trust to improve, relative to traditional configurations, an ease of binding one or more such devices into a security trust domain associated with protected content. For example, the method 300 may not require any binding-exclusive (e.g., authorization-exclusive, verification-exclusive, etc.) manual inputs to any of the devices involved in the method 300. Further, the method 300 may not require a physical connection between devices, etc. The method 300 may be particularly useful with respect to devices not associated with DRM binding, such as hearing aids or other accessibility-based devices, although it should be understood that the method 300 is also applicable to (and improves upon binding techniques associated with) any device with playback or interactivity capabilities. These and other aspects of the method 300 are described in detail below with reference to FIG. 3. It should be noted that the method 300 is not limited to binding a device into a security domain to gain access to DRM protected content only; instead, the method 300 may be adopted to gain access to any protected content or data associated with the protected content.

In the illustrated embodiment, the method 300 includes identifying (block 302) protected content to be accessed via the trust-based access service 104. For example, the audio-based trust data outputted by the trust-facilitating service 102 may correspond to a specific protected content stored in the trust-protected content repository 112 or a group of protected content stored in the trust-protected content repository 112. In this example, the audio-based trust data outputted by the trust-facilitating service 102 is indifferent to the trust-based access service 104, and any access services that may receive and process the audio-based trust data may access the corresponding protected content. As another example, a user of the trust-based access service 104 may provide an input on a device associated with the trust-based access service 104 specifying a particular protected content to be accessed and/or other data may identify the protected content to be accessed.

The trust data provider 108 may generate trust data corresponding to the particular protected content for the trust data encoder 106 to generate corresponding audio-based trust data. In some instances, the audio-based trust data may provide an indication of the protected content it is associated with, enabling the identification of the protected content to be accessed at block 302.

The method 300 may also include receiving (block 304), from the trust-facilitating service 102, an outputted audio signal corresponding to the protected content and having audio-based trust data therein. For example, the audio signal may be embedded in the protected content and output by the trust-facilitating service 102 as the trust-facilitating service 102 plays content associated with the protected content. In some aspects, the audio signal includes a frequency or other characteristic(s) causing the audio signal to be imperceptible and/or obscured to human ears. In this way, the audio signal may not negatively affect a user experience as the DRM protected content is played by the trust-facilitating service 102.

In some instances, the audio-based trust data itself may be protected (e.g., requiring additional information for its use in establishing trust/accessing protected content). Thus, the method 300 may also include receiving (block 306) supplemental trust data associated with the audio signal, if any. For example, the supplemental trust data may include a cryptographic lock that may be “opened” using the trust data of the audio signal or vis versa. The supplemental trust data may be received prior to receiving the outputted audio signal, such as in electronic data. Returning to the theater example, it may be desirable to protect against non-paying audience members from establishing trust, thus supplemental trust data may be provided (e.g., to the trust-based access service 104) in response to ticket purchase of an event prior to the event occurring. In some aspects, the supplemental trust data may be requested and received in response to receiving the outputted audio signal, for example via a control instruction provided to the trust-based access service 104 via embedded data in the audio signal.

The method 300 may leverage or rely upon environment-based trust to enable binding of one or more such devices, such as a device associated with the trust-based access service 104, into the security realm associated with the protected content. As an example of such trust, the device could only establish trust for accessing the protected content, when the device is in an environment where it is capable of detecting the audio signal with the trust data corresponding to the protected content.

In some aspects, the device associated with the trust-based access service 104 may be a device, such as a hearing aid or other accessibility-based device. In other aspects, the device may be other types of devices, such as a storage device, a tablet computer, a smart phone, etc. As used herein the trust-based access service 104 does not necessarily require a device that provides protected content playback. In some instances, for example, the trust-based access service 104 may include a device that stores and/or presents protected content, such as electronic data, without providing audio or visual playback. In another instance, the trust-based access service 104 may include any electronic device that enables user interaction with protected electronic data.

The method 300 may also include extracting and decrypting or decoding (block 308), via the trust-based access service 104 and in response to detecting the audio signal, the audio-based trust data. In some aspects, the supplemental trust data interacts with and/or is used in the decryption or decoding of the audio-based trust data associated with the audio signal. For example, as mentioned above, the supplemental trust data may be referred to as a cryptographic lock and/or puzzle that is unlocked, opened, and/or solved in response to receiving (and/or decrypting or decoding) the audio-based trust data of the audio signal and applying the decrypted and/or decoded audio-based trust data to the cryptographic lock and/or puzzle or vis versa. In this way, the audio signal (or audio-based trust data thereof) may be referred to as a cryptographic key or a cryptographic puzzle piece, respectively, in some aspects.

The method 300 may also include, with the established trust, accessing (block 310), via the trust-based access service 104, at least a portion of the protected content. For example, device pairing may be established (e.g., between the device associated with the trust-based access service 104 and the trust-protected content repository 112 storing the protected content) in response to the audio-based trust data being extracted and decrypted or decoded. Additionally or alternatively, in response to the audio-based trust data being extracted and decrypted or decoded, certain information associated with the protected content may be provided and/or interpretable by the device associated with the trust-based access service 104. For example, in certain aspects where the device is a hearing aid, the hearing aid may be provided access to audio files and/or playback timing or clock files to enable the hearing aid to output audio of the protected content that is timed with, for example, video or text of the protected content played by other trusted device(s), such as a device associated with the trust-facilitating service 102. Other portions of the protected content accessed by the trusted device(s) may include, for example, closed captioning files that are not provided to the hearing aid.

In some aspects, the device associated with the trust-based access service 104 may only be trusted to access a portion of the protected content and need to receive additional audio-based trust data to access an additional portion of the protected content. In such aspects, the method 300 may be iterated and directed back to block 304, where the device associated with the trust-based access service 104 an additional outputted audio signal corresponding to the protected content from the trust-facilitating service 102, such that the device may access the additional portion of the protected content. In some aspects, the device may receive the audio-based trust data corresponding to different portions of the protected content at consistent or adjustable periodic intervals.

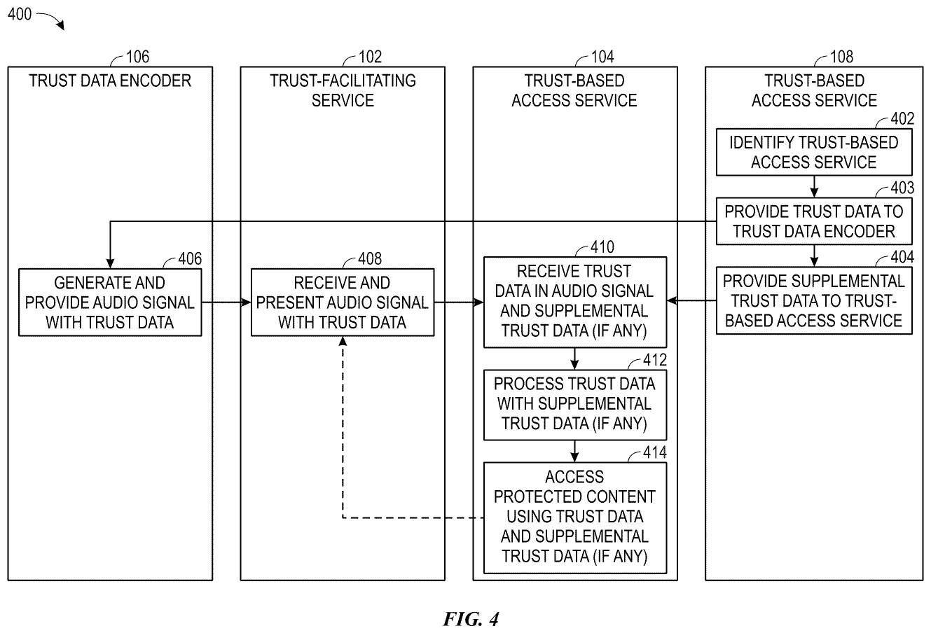

Method 300, as described above, may be adopted to any suitable content protection system (e.g., a DRM system) for binding one or more devices seeking to gain access rights to certain protected content. As previously discussed with respect to FIG. 1, the system (i.e., the system 100) may additionally include the trust data encoder 106 and the trust data provider 108 to facilitate distribution of trust data. With reference to FIG. 1, FIG. 4 is a process flow diagram illustrating a method 400, by which the system 100 and the like may bind the device associated with trust-based access service 104 into the security trust domain through the use of audio-based trust data.

It should be noted that, similar to method 300, the steps of the method 400 illustrated in FIG. 4 and described in detail below are exemplary and should not be taken to necessarily imply a chronological order of the method 400. While the steps of the method 400 may be performed in the order illustrated in FIG. 4, presently disclosed embodiments include any suitable ordering and/or chronology of these steps. Further, certain aspects of the method 400 may include steps other than those illustrated in FIG. 4. Further still, certain steps of the method 400 illustrated in FIG. 4 may be omitted and/or altered in other aspects.

As illustrated, the method 400 may include identifying (block 402), at the trust data provider 108, the trust-based access service 104 seeking access to the protected content. In some aspects, the trust data provider 108 may receive a request associated with the trust-based access service 104 or a device associated therewith for generating trust data corresponding to certain protected content. In response to such request, the trust data provider 108 may identify (e.g., analyze information related to, verify an identity of) the trust-based access service 104 or a device associated therewith. For example, the trust data provider 108 may be supplied with information such as whether the request from the trust-based access service 104 is associated with a paid subscriber of a certain service. The trust data provider 108 may accordingly identify the device(s) associated with the paid subscriber.

The method 400 may include providing (block 403), via the trust data provider 108, the generated trust data to trust data encoder 106, such that the trust data encoder 106 may produce the corresponding audio-based trust data. In some aspects, the trust data provider 108 may provide trust data specific to the certain protected content or a portion of the protected content. The trust data may be address and/or access information to the trust-protected content repository 112, binding and/or security information specific to a security trust domain, and/or any other protected information associated with the protected content.

The method 400 may include providing (block 404), via the trust data provider 108, any supplemental trust data to the trust-based access service 104. In some aspects, certain supplemental trust data may be necessary to access the certain protected content. For example, as previously described, the trust data provided to the trust data encoder 106 may be an encoded and/or encrypted form of the trust data that require complementary trust data such as a corresponding decoding and/or decryption scheme to the encrypted trust data. As such, in addition to identifying the trust-based access service 104 and providing the trust data to the trust data encoder 106, the trust data provider 108 may provide supplemental trust data to the trust-based access service 104, where the trust-based access service 104 may be seeking access to the certain protected content. For example, the trust data provider 108 may provide the supplemental trust data through an app update on a device associated with the trust-based access service 104. In some aspects, the trust data provider 108 may send a notification (e.g., pop-up window, visual alert, audible alert, physical alert) to the trust-based access service 104 and/or the device associated therewith indicative of an available app update indicative of eligibility of the trust-based access service 104 to the certain protected content. For example, the trust data provider 108 may receive information indicating that a user associated with the trust-based access service 104 has made a purchase associated with certain protected content and is seeking access to specialized audio playback on a specialized device of the user, where the access is included in the purchase. The trust data provider 108 may, upon receiving such information, identify the specialized playback device associated with the trust-based access service 104 and provide a notification, via an app installed on the specialized playback device and/or other user devices that may be associated with the trust-based access service 104, to the specialized device and/or the other user devices that may be associated with the trust-based access service 104 notifying the user to perform certain tasks (e.g., download certain files, update the app) to enable the trust-based access service 104 to decrypt an audio signal to be detected by the trust-based access service 104. Once the user completes the certain tasks, the supplemental trust data may become stored in the said device associated with the trust-based access service 104, enabling the device to detect and decrypt/decode the audio signal containing the trust data associated with the protected content. In another aspect, the supplemental trust data may be pre-installed into the device associated with the trust-based access service 104. Alternatively or additionally, the supplemental trust data may be transmitted to the device via another audio signal.

The method 400 may include generating and providing (block 406), via the trust data encoder 106, the audio signal containing the trust data associated with the protected content. For example, the trust data encoder 106 may generate an audio signal with trust data embedded into the audio signal for use with the supplemental trust data provided to the trust-based access service 104.

The method 400 may include receiving and presenting (block 408), via the trust-facilitating service 102, the audio signal containing the trust data associated with the protected content. For example, in the context of a trusted speaker system within a theater, the audio signal may include primary audio content associated with content being presented in the theater with embedded trust data. In some cases, the embedded trust data may be an overlaid audio layer that is not perceivable by the human ear, but is perceivable by a listening device associated with the trust-based access service 104.

The method 400 may include receiving (block 410), at the trust-based access service 104, the audio signal containing the trust data and, if any, the supplemental trust data corresponding to the protected content. For instance, returning to the theater example, the supplemental trust data may be provided via a ticket purchasing app, in response to tickets purchased via the device associated with the trust-based access service 104 and/or by a user associated with the trust-based access service 104. The device associated with the trust-based access service 104 may receive the audio signal when the audio signal is presented by the speaker system within the theater.

The method 400 may include processing (block 412), at the trust-based access service 104, the trust data in the audio signal and the supplemental trust data, if applicable. As mentioned above, this may entail applying the embedded trust data to a corresponding cryptographic lock to unlock, open, and/or solve the cryptographic lock. In other aspects, this may entail concatenating the trust data in the audio signal with the supplemental trust data and/or any other processing steps to combine the two pieces of data.

The method 400 may include accessing (block 414), via the trust-based access service 104, the protected content corresponding to the trust data and supplemental trust data (if any). For example, in some cases, the trust data may provide the device associated with the trust-based access service 104 with decrypted protected content. In some cases, the trust data may provide an indication of a location and/or access instructions for protected content and/or credentials for accessing the protected content.

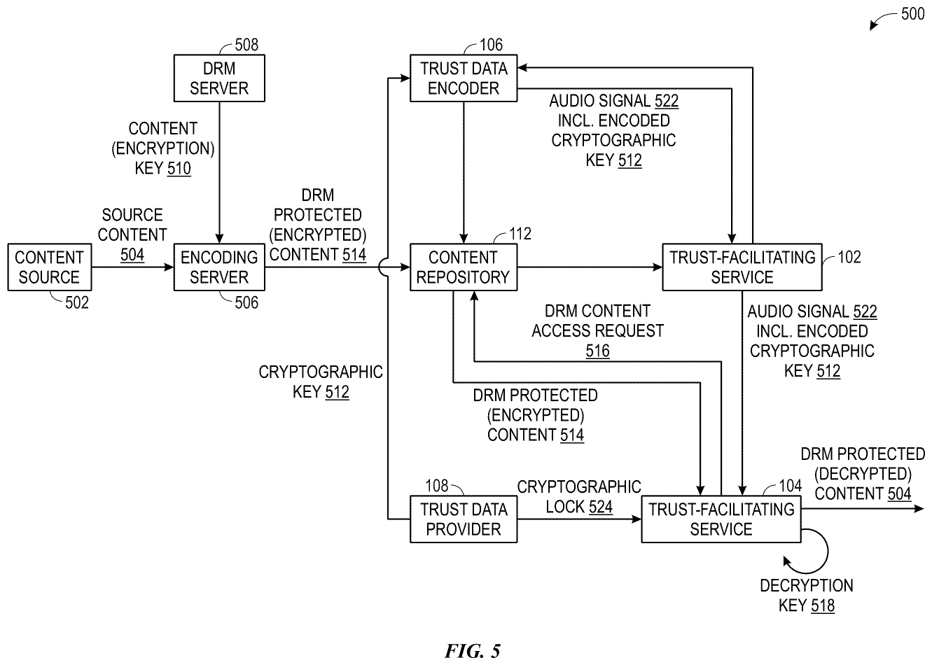

Method 400, as described above, may be adopted to any suitable protected content system, such as a DRM system, which may bind access rights to one or more devices seeking to gain access rights to certain protected content. With reference to FIG. 4, FIG. 5 illustrates a DRM system 500 including the system described in FIG. 1 for controlling and tracking playback of protected content, where the protected content may include digital video content and/or digital audio content. In should be noted that the present disclosures are not limited to adoption to DRM systems; instead, the present disclosures may be adopted to any suitable system for facilitating access rights to any form of protected content.

Referring to FIG. 5, a content source 502 may produce a source content 504 to be protected using various DRM techniques. An encoding server 506 may perform various processing steps (e.g., content encoding, packaging, and/or encryption) through a processing software. For example, the processing steps may include encoding the source content 504 based on a specific compressing standard (e.g., H.264/MPEG-4 AVC, VP9, and H.265/HEVC), resolution, bit rate, and frame rate at a significantly smaller size. As another example, the processing steps may include packaging the source content 504 based on a specific structure that may be supported by a user's player (e.g., ISO Base Media File Format (ISOBMFF), 3GPP TS). In some aspects, the packaging process introduces information based on certain supported streaming protocols and certain rules to send segments of the source content 504. As a further example, the processing steps may include encrypting the source content 504 based on a certain encryption standard (e.g., RSA, AES, ECC). In some aspects, certain metadata, such as Protection System Specific Header (e.g., PSSH) may be added to the signal to identify the DRM solution used to encrypt the source content 504.

During the encryption process, a DRM server 508 providing a key service may generate a content (encryption) key 510 to encrypt the source content 504 into DRM protected (encrypted) content 514. The key service of the DRM server 508 may synchronize the content (encryption) key 510 it generates with a cryptographic key 512 generated by a trust data provider (e.g., the trust data provider 108) providing a license service. In some aspects, this may mean that the cryptographic key 512 may be a decryption key that enables decryption of the DRM protected (encrypted) content 514. In some aspects, the cryptographic key 512 may be indirectly synchronized, for example, by providing a key for opening a cryptographic lock 524 that provides the decryption key useful for decrypting the DRM protected (encrypted) content 514.

As mentioned above, once the source content 504 is encoded, packaged, and encrypted, the source content 504 may become DRM protected (encrypted) content 514. The DRM protected (encrypted) content 514 may be stored in a content repository 112 and may be streamed to the user upon their request. For example, the device associated with the trust-based access service 104 may send a DRM content access request 516 to a device or service where the DRM protected (encrypted) content 514 is it be accessed from. In the depicted example this may be the content repository 112, but, in some aspects, this may be via another trust-facilitating service (e.g., the trust-facilitating service 102), which has been authorized to provide access to the DRM protected (encrypted) content 514.

To access the DRM protected (encrypted) content 514, the device associated with the trust-based access service 104 may need to provide authentication information. The DRM content access request 516 may include the authentication information authorizing the device associated with the trust-based access service 104 to receive and/or decrypt the DRM protected (encrypted) content 514. When such authentication information is provided in the DRM content access request 516, the content repository 112 may provide access to the DRM protected (encrypted) content 514.

In some aspects, such as the one depicted, the device associated with the trust-based access service 104 itself may decrypt the DRM protected (encrypted) content 514 using decryption key(s) 518 it identifies using the cryptographic key 512. Upon receiving the DRM content access request 516 at the content repository 112, the content repository 112 may distribute the DRM protected (encrypted) content 514 via a Content Delivery Network (CDN). In some aspects, the CDN may use certain application protocols, such as Hypertext Transfer Protocol Secure (HTTPS), and cache the DRM protected (encrypted) content 514 at the trust-facilitating service 102.

To decrypt the DRM protected (encrypted) content 514 for playback, the decryption keys may be identified using the cryptographic key 512 obtained via interpreting embeddings in the audio signal 522 (e.g., an audio track) supplied by the trust-facilitating service 102. In some cases, the cryptographic key 512 is used to open a cryptographic lock 524 provided by the trust data provider 108, which may result in provision of the decryption key(s) 518. In some cases, the cryptographic key 512 may be the decryption key(s) 518, where the cryptographic lock 524 is the DRM encryption of the DRM protected (encrypted) content 514.

Additionally, the DRM server 508 and/or trust data provider 108 providing the license service may also provide applicable usage rules, where usage rules may define what the user may be able to do with the DRM protected (encrypted) content 514. For example, the usage rules may define how long the source content 504 may be playable via the trust-facilitating service 102 or whether it is allowed to store the DRM license persistently on the trust-facilitating service 102.

Alternatively or additionally, the usage rules may include information corresponding to cryptographic key 512 provision constraints, such as regional restriction(s) as to one or more specific locations at which the audio signal 522 and/or cryptographic key 512 may be played back, and/or timing restrictions indicating a specific time(s) or time period(s) at which such provision may occur.

By way of example, the DRM license may include playback time and location restrictions, such as indicating that playback is to occur between the times of 5:00 PM and 8:00 PM in Mumbai, India. In this manner, a time period may indicate a period for which the DRM license is effectively valid. In another example, the DRM license may include a counter that serves to limit the number of times the source content 504 may be played back within a time period. In some aspects, the decryption key(s) 518 may be permitted to decrypt the DRM protected (encrypted) content 514 based on determination that geographical playback restriction/rules, timing playback restrictions/rules, and/or playback count limits included in the DRM license are satisfied. In contrast, decryption may be blocked, thus preventing access to the DRM protected (encrypted) content 514, based on determination that any of the geographical playback restriction/rules, timing playback restrictions/rules, and/or playback count limits included in the DRM license is not satisfied.

When cryptographic key 512 provision constraints are present, the audio signal 522 provision (e.g., by the trust-facilitating service 102) may be constrained. For example, the audio signal 522 may be constrained to playback during certain times, dates, and/or locations.

In some aspects, the trust-based access service 104 may be subject to the usage rules included in the DRM license to the trust-facilitating service 102. Accordingly, the trust-based access service 104 may be permitted to decrypt the DRM protected (encrypted) content 514 based on determination that geographical playback restriction/rules, timing playback restrictions/rules, and/or playback count limits included in the DRM license are satisfied. In contrast, trust-based access service 104 may be blocked from accessing the DRM protected (encrypted) content 514 based on determination that any of the geographical playback restriction/rules, timing playback restrictions/rules, and/or playback count limits included in the DRM license is not satisfied. In some aspects, the trust-based access service 104 may be subject to additional usage rules. For example, a device associated with the trust-based access service 104 may be blocked from accessing the DRM protected (encrypted) content 514 upon determining that the device is no longer at a geographical location (e.g., a geographical location of the trust-facilitating service 102) or within a certain distance threshold from the trust-facilitating service 102.

The various devices, service providers, and the like described herein may be implemented on a computer by execution of software comprising machine instructions read from computer-readable medium, as discussed above. In certain aspects, several hardware aspects may be implemented using a single computer; in other aspects, multiple computers, input/output systems and hardware may be used to implement the system.

For a software implementation, certain aspects described herein may be implemented with separate software modules, such as procedures and functions, each of which performs one or more of the functions and operations described herein. The software codes can be implemented with a software application written in any suitable programming language and may be stored in memory and executed by a controller or processor.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving, at a first electronic device, an audio signal, wherein the audio signal comprises embedded trust data configured to enable access to protected content;
extracting, via the first electronic device, the trust data form the audio signal; and
accessing at least a portion of the protected content using the extracted trust data.

2. The method of claim 1, wherein the embedded trust data enables establishment of a trust relationship between the first electronic device and a second electronic device protecting the protected content for a limited time period; and wherein the method comprises extracting second embedded trust data from the audio signal to maintain the trust relationship beyond the limited time period.

3. The method of claim 1, wherein:
the protected content is protected via encryption; and
the extracted trust data comprises a decryption key for the encryption.

4. The method of claim 1, comprising:
receiving supplemental trust data associated with the embedded trust data; and
process the embedded trust data with supplemental trust data to access the at least a portion of the protected content.

5. The method of claim 1, wherein the embedded trust data is identified from a frequency outside of an audible range perceptible to human ears.

6. The method of claim 1, wherein the extracted trust data comprises an indication of a location, an access credential, or both, enabling access to the at least a portion of the protected content.

7. The method of claim 1, wherein the protected content comprises audio content, video content, image content, or any combination thereof associated with content playing in parallel with the audio signal in a venue.

8. The method of claim 1, wherein the extracted trust data comprises an electronic command;
and the method comprises executing the electronic command.

9. The method of claim 8, wherein the electronic command comprises unlocking a controlled-access lock to gain access to an area.

10. A system, comprising:
an audio signal provider configured to provide an audio signal, wherein the audio signal comprises embedded access information configured to enable access to protected content; and
a first electronic device, configured to receive the audio signal from the audio signal provider and present the audio signal, enabling a second electronic device to:
receive the audio signal;
decrypt, decode, or both, the access information from the audio signal; and
access at least a portion of the protected content using the access information.

11. The system of claim 10, wherein the first electronic device is configured to present the audio signal to a limited physical environment that is authorized for access to the protected content.

12. The system of claim 10, wherein the first electronic device is configured to:
receive audio signal presentation constraints; and
present the audio signal in accordance with the audio signal presentation constraints.

13. The system of claim 12, wherein the audio signal presentation constraints indicate a presentation date, presentation time, presentation duration, presentation geographical location, or any combination thereof.

14. The system of claim 10 wherein the audio signal comprises a base audio layer and an overlaid audio layer, the overlaid audio layer comprising the embedded access information.

15. The system of claim 10, comprising a cryptographic lock provider, configured to provide a cryptographic lock accessible using the access information, wherein the cryptographic lock, when accessed, provides second access information that is used to access the at least a portion of the protected content.

16. A tangible, non-transitory, computer-readable medium, comprising computer-readable instructions that, when executed by one or more processors of one or more computers, causes the one or more computers to:
provide environment-based access to protected content by one or more electronic devices, by:
presenting, in an access-authorized environment, an audio signal, wherein the audio signal comprises embedded access information useful for the one or more electronic devices to access the protected content.

17. The tangible, non-transitory, computer-readable medium of claim 16, wherein the access information comprises access information for a plurality of different protected contents based upon a tier associated with the one or more electronic devices.

18. The tangible, non-transitory, computer-readable medium of claim 16, wherein the access information comprise a cryptographic key that enables opening of a cryptographic lock, wherein the cryptographic lock, when opened, provides second access information that enables access to the protected content.

19. The tangible, non-transitory, computer-readable medium of claim 16, comprising computer-readable instructions that, when executed by the one or more processors of the one or more computers, causes the one or more computers to:
receive access constraints for accessing the protected content by the one or more electronic devices; and
alter the presenting of the audio signal based upon the access constraints.

20. The tangible, non-transitory, computer-readable medium of claim 19, wherein the access constraints comprise a date range, time range, geographical location, or any combination thereof where access to the protected content is permitted.
